(19) United States
(12) Patent Application Publication
(10) Pub. No.: US 2020/0066453 A1
(43) Pub. Date: Feb. 27, 2020

(54) MULTILAYER CAPACITOR

(71) Applicant: SAMSUNG ELECTRO-MECHANICS CO., LTD., Suwon-si (KR)

(72) Inventors: Young Bin JEONG, Suwon-si (KR); Hoe Chul JUNG, Suwon-si (KR); Chi Hwa LEE, Suwon-si (KR)

(21) Appl. No.: 16/164,453

(22) Filed: Oct. 18, 2018

(30) Foreign Application Priority Data
Aug. 21, 2018 (KR) 10-2018-0097375

(51) Int. Cl. H01G 4/30; H01G 4/012; H01G 4/248; H01G 4/232

(52) U.S. Cl. CPC H01G 4/30; H01G 4/012; H01G 4/12; H01G 4/232; H01G 4/248

(57) ABSTRACT

A multilayer capacitor includes a body including dielectric layers and first and second internal electrodes and first and second external electrodes disposed on opposing ends of the body and connected to the first and second internal electrodes, respectively, wherein ends of the first and second internal electrodes are bent toward the center of the body in a thickness direction and exposed to opposing end surfaces of the body and upper and lower surfaces of the first and second external electrodes are coplanar with upper and lower surfaces of the body, respectively.

### CROSS-REFERENCE TO RELATED APPLICATION

This application claims the benefit of priority to Korean Patent Application No. 10-2018-0097375 filed on Aug. 21, 2018 in the Korean Intellectual Property Office, the disclosure of which is incorporated herein by reference in its entirety.

### TECHNICAL FIELD

The present disclosure relates to a multilayer capacitor.

### BACKGROUND

Multilayer capacitors, having advantages such as compactness, guaranteed high capacity, and ease of mountability, are mounted on the circuit boards of various electronic products such as image displays including liquid crystal displays (LCDs) and plasma display panels (PDPs), computers, smartphones, cellular phones, and the like, to charge or discharge electricity.

Such multilayer capacitors include a body including dielectric layers and internal electrodes, and external electrodes.

The related art external electrodes are formed by applying a conductive paste to a surface of the body by a dipping method.

However, due to characteristics of the dipping method and surface tension of the conductive paste applied to the surface of the body, the external electrodes covers the end of the body while having a rounded shape, and as a result, the radius of the width-thickness cross-section of the external electrodes is excessively larger than an area of the width-thickness cross-section of the body.

Recently, as electronic components have become compact, multilayer capacitors have also been required to be miniaturized and a mounting volume thereof is required to be reduced, and here, if the radius of the width-thickness cross-section of the external electrodes is excessively larger than the area of the width-thickness cross-section of the body, a greater mounting volume is required when the multilayer capacitor is mounted on a board.

### SUMMARY

An aspect of the present disclosure may provide a multilayer capacitor which may be reduced in mounting volume when mounted.

According to an aspect of the present disclosure, a multilayer capacitor may include: a body including dielectric layers, first internal electrodes, and second internal electrodes; and first and second external electrodes disposed on end surfaces of the body opposing each other in a length direction and electrically connected to the first and second internal electrodes, respectively, wherein ends of the first and second internal electrodes, which are exposed to the end surfaces of the body, are bent toward a center of the body in a stacking direction, and upper and lower surfaces of the first and second external electrodes in the stacking direction are coplanar with upper and lower surfaces of the body in the stacking direction, respectively.

The body may further include front and rear surfaces opposing each other in a width direction, which are connected to the end surfaces of the body in the length direction and connected to the upper and lower surfaces of the body in the stacking direction.

A cross-sectional area of each of the first and second external electrodes in a width-stacking direction may be substantially equal to a cross-sectional area of the body in the width-stacking direction.

Edges of the body where the end surfaces and the upper and lower surfaces meet may be rounded toward the center of the body in the length and stacking directions.

An average thickness of the dielectric layers and an average thickness of the first and second internal electrodes may be 0.4 μm or less, and on the end surfaces of the body to which the first and second internal electrodes are exposed, gaps between adjacent layers among the first internal electrodes and gaps between adjacent layers among the second internal electrodes may be 0.8 μm or less.

The multilayer capacitor may have a total length of 10 mm or less and a total width of 5 mm or less.

One ends of the first and second internal electrodes may be alternately exposed to the end surfaces of the body with each of the dielectric layers interposed therebetween.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a multilayer capacitor according to an exemplary embodiment in the present disclosure;

FIGS. 2A and 2B are plan views respectively illustrating first and second internal electrodes applied to the multilayer capacitor of FIG. 1;

FIG. 3 is a cross-sectional view taken along the line I-I′ in FIG. 1; and

FIG. 4 is a cross-sectional view taken along the line II-II′ of FIG. 1.

### DETAILED DESCRIPTION

Hereinafter, exemplary embodiments in the present disclosure will be described in detail with reference to the accompanying drawings. In the accompanying drawings, shapes, sizes, and the like, of components may be exaggerated or stylized for clarity.

The present disclosure may, however, be exemplified in many different forms and should not be construed as being limited to the specific embodiments set forth herein. Rather these embodiments are provided so that this disclosure will be thorough and complete, and will fully convey the scope of the disclosure to those skilled in the art.

The term “an exemplary embodiment” used herein does not refer to the same exemplary embodiment, and is provided to emphasize a particular feature or characteristic different from that of another exemplary embodiment. However, exemplary embodiments provided herein are considered to be able to be implemented by being combined in whole or in part one with another. For example, one element described in a particular exemplary embodiment, even if it is not described in another exemplary embodiment, may be understood as a description related to another exemplary embodiment, unless an opposite or contradictory description is provided therein.

The meaning of a “connection” of a component to another component in the description includes an indirect connection through a third component as well as a direct connection between two components. In addition, “electrically connected” means the concept including a physical connection and a physical disconnection. It can be understood that when an element is referred to with “first” and “second”, the element is not limited thereby. They may be used only for a purpose of distinguishing the element from the other elements, and may not limit the sequence or importance of the elements. In some cases, a first element may be referred to as a second element without departing from the scope of the claims set forth herein. Similarly, a second element may also be referred to as a first element.

Herein, an upper portion, a lower portion, an upper side, a lower side, an upper surface, a lower surface, and the like, are decided in the accompanying drawings. For example, a first connection member is disposed on a level above a redistribution layer. However, the claims are not limited thereto. In addition, a vertical direction refers to the abovementioned upward and downward directions, and a horizontal direction refers to a direction perpendicular to the abovementioned upward and downward directions. In this case, a vertical cross section refers to a case taken along a plane in the vertical direction, and an example thereof may be a cross-sectional view illustrated in the drawings. In addition, a horizontal cross section refers to a case taken along a plane in the horizontal direction, and an example thereof may be a plan view illustrated in the drawings.

Terms used herein are used only in order to describe an exemplary embodiment rather than limiting the present disclosure. In this case, singular forms include plural forms unless interpreted otherwise in context.

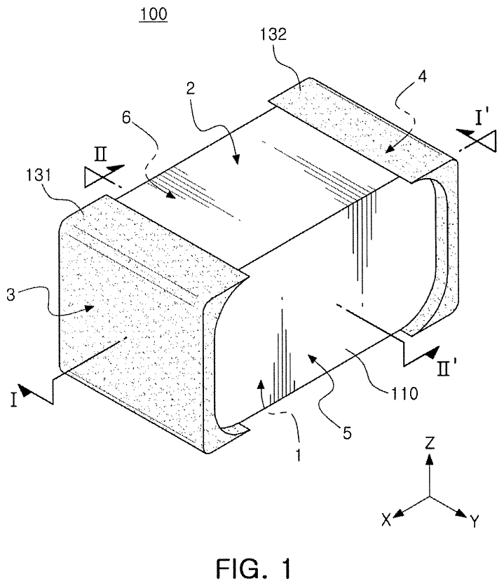

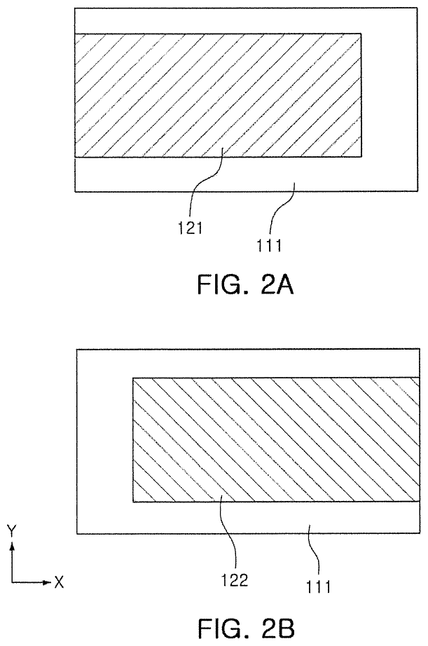

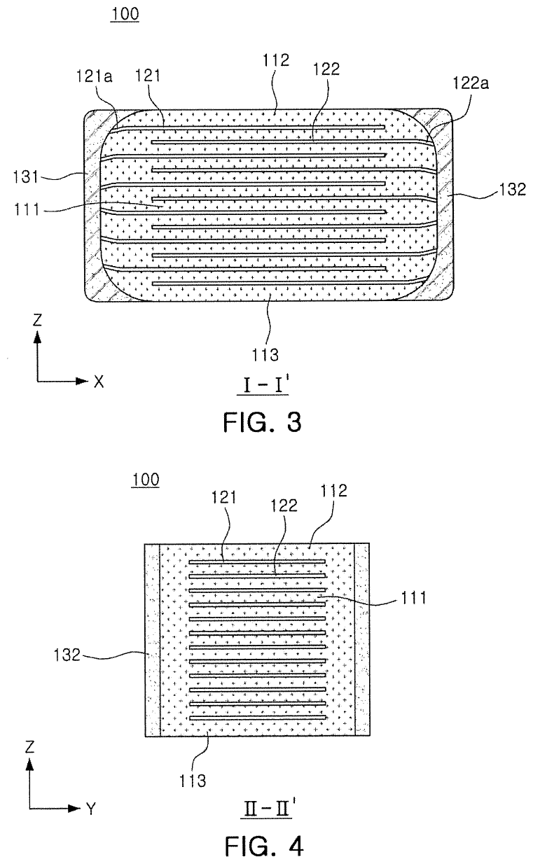

FIG. 1 is a perspective view schematically illustrating a multilayer capacitor according to an exemplary embodiment in the present disclosure, FIGS. 2A and 2B are plan views respectively illustrating first and second internal electrodes applied to the multilayer capacitor of FIG. 1, FIG. 3 is a cross-sectional view taken along the line I-I′ in FIG. 1, and FIG. 4 is a cross-sectional view taken along the line II-II′ of FIG. 1.

Referring to FIGS. 1 to 4, a multilayer capacitor 100 according to the present exemplary embodiment includes a body 110 including a multilayer structure of dielectric layers 111 and first and second internal electrodes 121 and 122, and first and second external electrodes 131 and 132.

The body 110 is formed by stacking a plurality of dielectric layers 111 in the Z direction, or stacking direction, and sintering the same, and adjacent dielectric layers 111 of the body 110 may be integrated such that boundaries therebetween may not be readily apparent without using a scanning electron microscope (SEM).

Here, the body 110 may have a substantially hexahedral shape but the present disclosure is not limited thereto.

The shape and dimensions of the body 110 and the stacking number of the dielectric layer 111 are not limited to those illustrated in the drawings of the present exemplary embodiment.

For the purposes of explanation, surfaces of the body 110 opposing each other in the Z direction are defined as first and second surfaces 1 and 2, and surfaces connected to the first and second surfaces 1 and 2 and opposing each other in the X direction, or length direction, will be defined as third and fourth surfaces 3 and 4, and surfaces connected to the first surfaces 1 and 2, connected to the third and fourth surfaces 3 and 4, and opposing each other in the Y direction, or width direction, will be defined as fifth and sixth surfaces 5 and 6.

In the present exemplary embodiment, amounting surface of the multilayer capacitor 100 may be the first surface 1 of the body 110.

In the multilayer capacitor 100 of the present exemplary embodiment, a total length in the X direction may be 10 mm or less and a total width in the Y direction may be 5 mm or less.

The dielectric layer 111 may include a ceramic material having a high dielectric constant, e.g., a barium titanate (BaTiO₃)-based or a strontium titanate (SrTiO₃)-based ceramic powder. However, the present disclosure is not limited thereto as long as sufficient capacitance is obtained.

A ceramic additive, an organic solvent, a plasticizer, a binder, a dispersant, and the like, may be further added to the dielectric layer 111 together with the ceramic powder.

The ceramic additive may be, for example, a transition metal oxide or a transition metal carbide, a rare earth element, magnesium (Mg), aluminum (Al), or the like.

The body 110 includes an active region serving as part contributing to capacity formation of the capacitor and upper and lower covers 112 and 113 formed respectively on upper and lower surfaces of the active region in the Z direction as upper and lower margin portions.

The upper and lower covers 112 and 113 may be formed of the same material and have the same configuration as those of the dielectric layer 111 except that they do not include an internal electrode.

The upper and lower covers 112 and 113 may be formed by stacking a single dielectric layer or two or more dielectric layers on the upper and lower surfaces of the active region in the Z direction, respectively. The upper and lower covers 112 and 113 may basically serve to prevent damage to the second internal electrodes 121 and 122 due to physical or chemical stress.

The first and second internal electrodes 121 and 122, which are provided with the opposite polarities, are alternately arranged in the Z direction with the dielectric layer 111 interposed therebetween, and one ends thereof may be exposed to the third and fourth surface 3 and 4 of the body 110, respectively.

Here, the first and second internal electrodes 121 and 122 may be electrically insulated from each other by the dielectric layer 111 disposed therebetween.

Ends 121a and 122a of the first and second internal electrodes 121 and 122 exposed to the third and fourth surfaces 3 and 4 of the body 110 are bent toward the center of the body 110 in the Z direction.

The ends of the first and second internal electrodes 121 and 122 alternately exposed to the third and fourth surfaces 3 and 4 of the body 110 may be electrically connected to the first and second external electrodes 131 and 132 disposed on the third and fourth surfaces 3 and 4, respectively.

When a predetermined voltage is applied to the first and second external electrodes 131 and 132, charges are accumulated between the first and second internal electrodes 121 and 122.

Here, capacitance of the multilayer capacitor 100 is proportional to an area of the active region in which the first and second internal electrodes 121 and 122 overlap each other in the Z direction.

A material for forming the first and second internal electrodes 121 and 122 is not limited and the first and second internal electrodes 121 and 122 may be formed of a conductive paste including one or more materials among precious metals such as platinum (Pt), palladium (Pd), palladium-silver (Pd—Ag), and the like, and nickel (Ni) and copper (Cu).

The material for forming the first and second internal electrodes 121 and 122 is not particularly limited and may be, for example, platinum (Pt), palladium (Pd), palladium-silver (Pd—Ag), and a conductive paste made of at least one of nickel (Ni) and copper (Cu).

Here, a screen printing method, a gravure printing method, or the like, may be used for printing the conductive paste but the present disclosure is not limited thereto.

Meanwhile, in the body 110 of the present exemplary embodiment, an average thickness of the dielectric layer 111 is 0.4 μm or less and an average thickness of the first and second internal electrodes 121 and 122 is 0.4 μm or less.

On the third and fourth surfaces 3 and 4 of the body 110 to which the first or second inner electrodes 121 and 122 are exposed, gaps between adjacent layers among the first inner electrodes 121 and gaps between adjacent layers among the second internal electrodes 122 may be 0.8 μm or less.

The first and second external electrodes 131 and 132 are provided with voltages of the opposite polarities and disposed on the third and fourth faces 3 and 4 at opposing ends of the body 110 in the X direction, respectively.

Thus, the first and second external electrodes 131 and 132 may be electrically connected to portions where the ends 121a and 122a of the first and second internal electrodes 121 and 122 are exposed to the third and fourth surfaces 3 and 4 of the body 110.

Here, the upper surfaces of the first and second external electrodes 131 and 132 are coplanar with the second surface 2, the upper surface, of the body 110, and the lower surfaces of the first and second external electrodes 131 and 132 are coplanar with the first surface 1, the lower surface, of the body 110.

Here, the first and second external electrodes 131 and 132 may further include a plating layer.

The plating layer may include a nickel plating layer and a tin (Sn) plating layer covering the nickel plating layer.

As the multilayer capacitor is reduced in size, the radius of the Y-Z cross-section of the external electrodes must be reduced to reduce a mounting volume when mounted on a board.

Assuming that no contraction occurs in the body, in order to minimize the radius of the Y-Z cross-section of the external electrodes 131 and 132, the radius of the Y-Z cross-section of the external electrodes 131 and 132 should be reduced to be equal to or nearly equal to the radius of the Y-Z cross-section of the body 110.

It is natural that the ends of the body contracts, and according to the present exemplary embodiment, the ends 121a and 122a of the first and second internal electrodes 121 and 122 exposed to the third and fourth surfaces 3 and 4 of the body 110 are further curved toward the center of the body 110 in the Z direction, and thus, steps that occur at both ends of the body 110 in the X direction are further intensified.

That is, the upper and lower ends severely contract on the third and fourth surfaces 3 and 4 of the body 110, relative to general multilayer capacitors, as a result, opposing ends of the body 110 in the X direction are significantly narrowed, relative to the central portion.

Thus, the first and second external electrodes 131 and 132 may be formed in the space generated as the ends of the body 110 in the X direction are narrowed, and since the lengths of the first and second external electrodes 131 and 132 in the Z direction are reduced, upper and lower surfaces of the first and second external electrodes 131 and 132 in the Z direction are coplanar with the second and first surfaces 2 and 1 of the body 110, respectively.

Through this configuration, the lengths of the first and second external electrodes 131 and 132 in the Z direction are reduced, reducing the area of the Y-Z cross-section, relative to the area of the Y-Z cross-section of the body of the related art multilayer capacitor, whereby the multilayer capacitor 100 in which the first and second external electrodes 131 and 132 do not protrude vertically in the Z direction of the body 110 may be manufactured, and thus, a volume required for the multilayer capacitor 100 to be mounted on a board may be reduced.

As set forth above, according to exemplary embodiments of the present disclosure, the upper and lower surfaces of the external electrodes 131 and 132 are coplanar with the upper and lower surfaces of the body 110, respectively, and thus, a mounting volume of the multilayer capacitor may be reduced.

While exemplary embodiments have been shown and described above, it will be apparent to those skilled in the art that modifications and variations could be made without departing from the scope of the present disclosure as defined by the appended claims.

1. A multilayer capacitor comprising:
a body including dielectric layers, first internal electrodes, and second internal electrodes in a stacking direction; and
first and second external electrodes disposed on end surfaces of the body opposing each other in a length direction and electrically connected to the first and second internal electrodes, respectively,
wherein ends of the first and second internal electrodes, which are exposed to the end surfaces of the body, are bent toward a center of the body in the stacking direction,
upper flat surfaces of the first and second external electrodes in the stacking direction are coplanar with an upper surface of the body in the stacking direction, and
lower flat surfaces of the first and second external electrodes in the stacking direction are coplanar with a lower surface of the body in the stacking direction.

2. The multilayer capacitor of claim 1, wherein
the body further includes front and rear surfaces opposing each other in a width direction, which are connected to the end surfaces of the body in the length direction and connected to the upper and lower surfaces of the body in the stacking direction.

3. The multilayer capacitor of claim 2, wherein
a cross-sectional area of each of the first and second external electrodes in a width-stacking direction is substantially equal to a cross-sectional area of the body in the width-stacking direction.

4. The multilayer capacitor of claim 2, wherein the multilayer capacitor has a total length of 10 mm or less in the length direction and a total width of 5 mm or less in the width direction.

5. The multilayer capacitor of claim 1, wherein
edges of the body where the end surfaces and the upper and lower surfaces of the body meet are rounded toward the center of the body in the length and stacking directions.

6. The multilayer capacitor of claim 1, wherein,
an average thickness of the dielectric layers and an average thickness of the first and second internal electrodes are 0.4 μm or less, and
on the end surfaces of the body to which the first and second internal electrodes are exposed, gaps between adjacent layers among the first internal electrodes and gaps between adjacent layers among the second internal electrodes are 0.8 μm or less.

7. The multilayer capacitor of claim 1, wherein
one ends of the first and second internal electrodes are alternately exposed to the end surfaces of the body with each of the dielectric layers interposed therebetween.

8. The multilayer capacitor of claim 1, wherein
inner surfaces of the first and second external electrodes, to which the first and second internal electrodes are exposed, each include a curved surface.

9. The multilayer capacitor of claim 1, wherein
along a width direction, a cross-sectional area of a center portion of each of the first and second external electrodes is the same as a cross-sectional area of an outermost portion of each of the first and second external electrodes, the width direction being perpendicular to the length and stacking directions.
